(19) United States
(12) Patent Application Publication
(10) Pub. No.: US 2024/0320550 A1
(43) Pub. Date: Sep. 26, 2024

(54) LEARNING SYSTEM AND LEARNING METHOD

(71) Applicant: NEC Corporation, Minato-ku, Tokyo (JP)

(72) Inventor: Tomoyuki Yoshiyama, Tokyo (JP)

(73) Assignee: NEC Corporation, Minato-ku, Tokyo (JP)

(21) Appl. No.: 18/575,363

(22) PCT Filed: Jul. 12, 2021
(86) PCT No.: PCT/JP2021/026148

§ 371 Date: Dec. 29, 2023

(51) Int. Cl. G06N 20/00

(52) U.S. Cl. CPC G06N 20/00

(57) ABSTRACT

The learning means 111 learns parameters of predetermined multiple operations that are related in that common input data is given and that weighted sum of output data is calculated, and parameters related to calculation of the weighted sum. The client-side parameter sending means 112 sends parameters of the predetermined multiple operations, among the parameters of the predetermined multiple operations and the parameters related to the calculation of the weighted sum, to the server 120. The parameter calculation means 121 recalculates the parameters of the predetermined multiple operations, based on the parameters of the predetermined multiple operations received from each client. The server-side parameter sending means 122 sends the parameters of the predetermined multiple operations to each client 110.

### TECHNICAL FIELD

The present invention relates to a learning system, a learning method, and a computer-readable recording medium in which a learning program is recorded, for learning parameters of a model, as well as an inference device.

### BACKGROUND ART

In general, in machine learning, the more learning data there is, a model with the higher inference accuracy can be learned. Therefore, it is considered that if multiple clients each have their own data, a server may collect data from each client, and the server may use that data as learning data to learn a model.

However, from the standpoint of individual clients, providing data to outside parties is undesirable from the standpoint of data leakage. This is especially true when the individual clients are managed by separate administrators (e.g., separate companies). For example, individual companies may not want to provide their own proprietary data to outside parties. Thus, it is often difficult for a server to collect data from each client and for the server to learn a model using the data as learning data.

Therefore, federated learning has been proposed. An example of federated learning is shown below. In federated learning, for example, the server provides an obtained model (referred to as the global model) to each client. Each client learns a model based on the global model and its own data. The model obtained by the client through learning is referred to as the local model. Each client sends the local model or the difference information between the global model and the local model to the server. The server updates the global model based on each local model (or each difference information) obtained from each client, and provides the global model to each client again. In this example of federated learning, the above process is repeated. For example, the server provides the global model to each client, and then the server updates the global model. Then, for example, it is determined that the learning ends when the number of repetitions of the above behavior reaches a predetermined number, and when the number of repetitions of the above behavior reaches the predetermined number, the global model obtained by the server is determined as the model that is the learning result.

In federated learning, each client need only provide the server with the local model or the differential information, and there is no need for each client to provide the server with its own data. The model can then be obtained as the same model as if the server had collected data from each client and learned the model. In other words, the server can obtain the model without providing the data that each client holds independently to the outside parties.

In federated learning, the goal is often to obtain the global model. In contrast, techniques have been proposed that allow each individual client to obtain a model that is appropriate for each client. Such a technique is called personalized federated learning. In general, each client holds similar but different data. For example, a client of a bank in one region (take A) and a client of a bank in another region (take B) each hold data of customer deposit amounts as learning data. Both of these learning data are similar data, being data of customer deposit amounts. However, the properties of the data may differ due to the differences in regionality. The differences in regionality will result in different models that are appropriate for the client of the bank in region A and for the client of the bank in region B. In personalized federated learning, each client obtains a model that is appropriate for each client.

An example of personalized federated learning is described in NPL 1. The technique described in NPL 1 is referred to as FedProx. FedProx uses an equation that adds the output of a loss function that evaluates the deviation between correct value and predicted value in the local model, and the deviation of the parameters of the global and local models.

Another example of personalized federated learning is described in NPL 2. The technique described in NPL 2 is referred to as FedFomo. In FedFomo, each client receives the local model of each other client, and each client separately weights each client's local model to obtain a model that is suitable for itself.

In addition to personalized federated learning, various techniques for deep learning have also been proposed (see NPL 3 and 4). NPL 3 describes using multiple fixed values obtained by learning to obtain a weighted sum of those fixed values according to the input values. For example, it is assumed that three fixed values, W₁, W₂, and W₃, are obtained by learning. In the technique described in NPL 3 (referred to as CondConv), the weight values corresponding to W₁, W₂, and W₃ are determined according to the input values, and the weighted sum of W₁, W₂, and W₃ is obtained with the weight values corresponding to the input values.

NPL 4 also describes learning the parameters of multiple convolution operations that are processed in parallel, when learning, and combining those multiple convolution operations into a single convolution operation during inference. For example, NPL 4 describes learning the parameters of convolution operations of a 3×3 filter and the parameters of convolution operations of a 1×1 filter, when learning, and combining those convolution operations into a single convolution operation of a 3×3 filter during inference. The technique described in NPL 4 is referred to as RepVGG.

### CITATION LIST

### Non-Patent Literature

NPL 1: Tian Li, et al, “Federated Optimization in Heterogeneous Networks”, [retrieved on Jun. 7, 2021], Internet, <URL:https://arxiv.org/pdf/1812.06127.pdf>
NPL 2: Michael Zhang, et al, “Personalized Federated Learning with First Order Model Optimization”, [retrieved on Jun. 7, 2021], Internet, <URL:https://arxiv.org/pdf/2012.08565.pdf>
NPL 3: Brandon Yang, et al, “CondConv: Conditionally Parameterized Convolutions for Efficient Inference”, [retrieved on Jun. 7, 2021], Internet, <URL:https://arxiv.org/pdf/1904.04971.pdf>
NPL 4: Xiaohan Ding, et al, “RepVGG: Making VGG-style ConvNets Great Again”, [retrieved on Jun. 7, 2021], Internet, <URL:https://arxiv.org/pdf/2101.03697.pdf>

### SUMMARY OF INVENTION

### Technical Problem

In the technique described in NPL 1 (FedProx), as mentioned above, an equation that adds the output of the loss function and the deviation of the parameters of the global and local models is used to obtain the local model. However, there are cases where the output of the model fluctuates significantly even if the deviation of the parameters is small, and cases where the output of the model does not fluctuate much even if the deviation of the parameters is large. In other words, the deviation of the parameters of the global and local model is not related to the properties of the output of the local model. As a result, the techniques described in NPL 1 are difficult to optimize and to obtain a highly accurate model for each client.

In addition, the technique described in NPL 2 (FedFomo) requires each individual client to provide each other client with the model it has generated. There is also a technique to recover the learning model used to learn the model from the model. Therefore, it is undesirable for individual clients to provide their own models to multiple other clients from the standpoint of reducing data leakage.

Therefore, the object of the present invention is to provide a learning system, a learning method, and a computer-readable recording medium in which a learning program is recorded, which can reduce the possibility of data leakage for each client and enable each client to obtain the parameters of a highly accurate model suitable for each client, and an inference device that performs inference with such a model.

### Solution to Problem

A learning system according to the present invention includes a server and multiple clients, wherein each client comprises: learning means for learning parameters of predetermined multiple operations that are related in that common input data is given and that weighted sum of output data is calculated, and parameters related to calculation of the weighted sum; and client-side parameter sending means for sending the parameters of the predetermined multiple operations, among the parameters of the predetermined multiple operations and the parameters related to the calculation of the weighted sum, to the server; wherein the server comprises: parameter calculation means for recalculating the parameters of the predetermined multiple operations, based on the parameters of the predetermined multiple operations received from each client; and server-side parameter sending means for sending the parameters of the predetermined multiple operations to each client.

An inference device according to the present invention includes inference means for deriving an inference result for given data based on a model determined by the parameters of the predetermined multiple operations and the parameters related to the calculation of the weighted sum that are obtained by such a learning system.

A learning method according to the present invention is performed by a server and multiple clients, wherein each client learns parameters of predetermined multiple operations that are related in that common input data is given and that weighted sum of output data is calculated, and parameters related to calculation of the weighted sum; and sends the parameters of the predetermined multiple operations, among the parameters of the predetermined multiple operations and the parameters related to the calculation of the weighted sum, to the server; and wherein the server recalculates the parameters of the predetermined multiple operations, based on the parameters of the predetermined multiple operations received from each client; and sends the parameters of the predetermined multiple operations to each client.

A computer-readable recording medium according to the present invention is a computer-readable recording medium in which a learning program is recorded, wherein the a learning program causes a computer to execute: a learning process of learning parameters of predetermined multiple operations that are related in that common input data is given and that weighted sum of output data is calculated, and parameters related to calculation of the weighted sum; and a parameter sending process of sending the parameters of the predetermined multiple operations, among the parameters of the predetermined multiple operations and the parameters related to the calculation of the weighted sum, to a server.

### Advantageous Effects of Invention

The present invention can reduce the possibility of data leakage for each client and enable each client to obtain the parameters of a highly accurate model suitable for each client.

### BRIEF DESCRIPTION OF DRAWING

FIG. 1 It depicts a schematic diagram showing predetermined multiple operations whose parameters are learned in federated learning.

FIG. 2 It depicts a schematic diagram showing the case where predetermined multiple operations 51, 52, 53 each include multiple layers.

FIG. 3 It depicts a schematic diagram showing the case where the number of layers included in predetermined multiple operations 51, 52, 53 is different.

FIG. 4 It depicts a schematic diagram showing an example of a model whose parameters are learned.

FIG. 5 It depicts a block diagram showing an example configuration of a learning system of the example embodiment of the present invention.

FIG. 6 It depicts a flowchart showing an example of the processing flow of the example embodiment of the present invention.

FIG. 7 It depicts a block diagram showing an example configuration of each client in a variation of the example embodiment of the present invention.

FIG. 8 It depicts a schematic diagram showing a model after conversion by the conversion unit.

FIG. 9 It depicts a block diagram showing an example configuration of each client in a variation of the example embodiment of the present invention.

FIG. 10 It depicts a block diagram showing an inference device that is a separate device from the client.

FIG. 11 It depicts a schematic diagram showing an example of computer configuration related to the client, the server, and the inference device in the example embodiment of the present invention and its various variations.

FIG. 12 It depicts a block diagram showing an overview of the learning system of the present invention.

### DESCRIPTION OF EMBODIMENTS

An example embodiment of the present invention is described below with reference to the drawings.

A learning system of the example embodiment of the present invention includes a server and multiple clients, as described below. In the example embodiment of the present invention, the server and each client learn the parameters of predetermined multiple operations in federated learning, and each client independently learns the parameters related to calculation of a weighted sum of output data of the predetermined multiple operations (hereinafter simply referred to as the parameters related to the calculation of the weighted sum). Therefore, the parameters of the predetermined multiple operations are the same for each client, but the parameters related to the calculation of the weighted sum are different for each client.

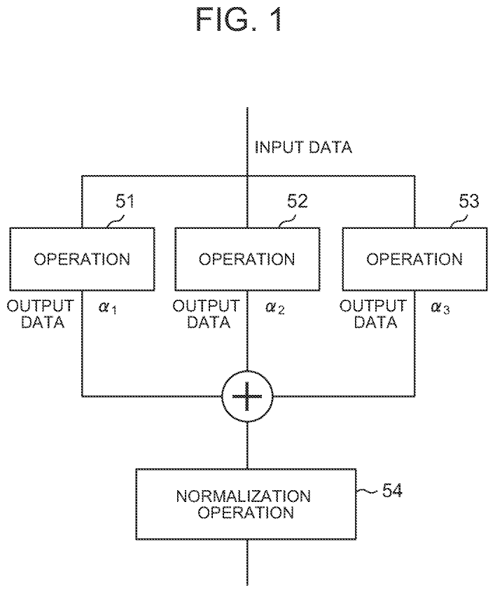

FIG. 1 is a schematic diagram showing the predetermined multiple operations whose parameters are learned in federated learning. The predetermined multiple operations are multiple operations that are related in that common input data is given and that weighted sum of output data is calculated. In FIG. 1, operations 51, 52, and 53 correspond to the predetermined multiple operations. That is, common input data is given to operations 51, 52, and 53, and the weighted sum of the output data of each of operations 51, 52, and 53 is calculated. The α₁, α₂, and α₃ shown in FIG. 1 are weight values used in calculating the weighted sum of the output data. Each weight value α₁, α₂, and α₃ is between 0 and 1, respectively, and the sum of each weight value α₁, α₂, and α₃ is 1.

In the example shown in FIG. 1, the parameters of the predetermined multiple operations 51-53 are learned by the server and each client in federated learning. In addition, α₁, α₂, and α₃ are the parameters related to the calculation of the weighted sum and are learned independently by each client.

Also illustrated in FIG. 1 is the normalization operation 54, which performs normalization on the weighted sum of the output data of the operations 51, 52, and 53, respectively. The parameters of normalization operation 54 are treated as the parameters related to the calculation of the weighted sum. Therefore, the parameters of the normalization operation 54 are learned independently by each client as well as α₁, α₂, and α₃. As an example of the normalization operation 54, a certain number (take β) is subtracted from the input data to the normalization operation 54, and the result of the subtraction is multiplied by a certain number (take γ). In this case, β and γ correspond to the parameters of the normalization operation 54. However, calculation and parameters in the normalization operation 54 are not limited to this example.

FIG. 1 shows the case where the number of the predetermined multiple operations is three, but the number of predetermined multiple operations is not limited to three. However, there is a restriction that the number of the predetermined multiple operations must be lower than the number of the clients.

The predetermined multiple operations 51, 52, 53 may include multiple layers.

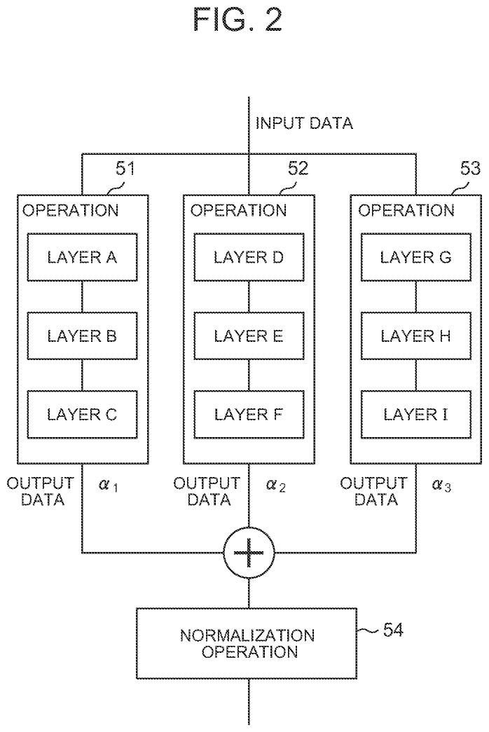

FIG. 2 is a schematic diagram showing the case where predetermined multiple operations 51, 52, 53 each include multiple layers. FIG. 2 illustrates the case where the operation 51 includes layers A-C, the operation 52 includes layers D-F, and the operation 53 includes layers G-I. In this case, the parameters of layers A-C are the parameters of the operation 51. Similarly, the parameters of layers D-F are the parameters of the operation 52, and the parameters of layers G-I are the parameters of the operation 53.

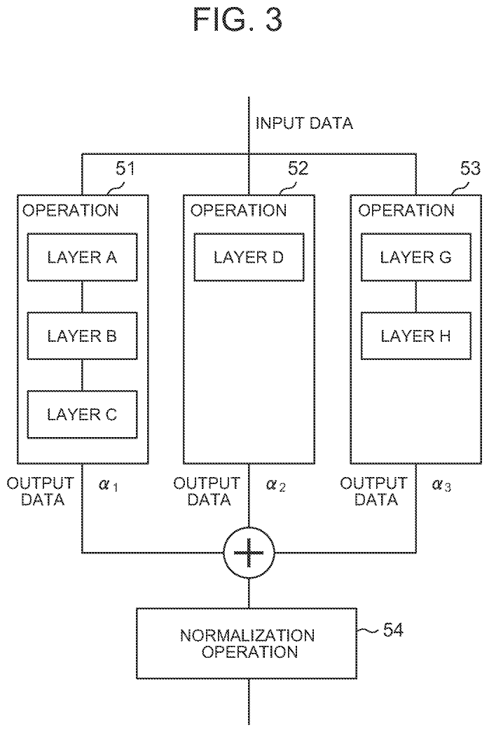

FIG. 3 is a schematic diagram showing the case where the number of layers included in predetermined multiple operations 51, 52, 53 is different. As shown in FIG. 3, the number of layers included in the predetermined multiple operations 51, 52, 53 may be different for each operation.

In the following explanation, for simplicity of explanation, the case where the predetermined multiple operations 51, 52, and 53 are convolution operations, respectively, is exemplified. Although a convolution operation is a linear operation, each of the predetermined multiple operations may or may not be a linear operation. For example, the predetermined multiple operations 51, 52, 53 may all be linear operations, and the predetermined multiple operations 51, 52, 53 may not all be linear operations. Also, some of the predetermined multiple operations 51, 52, 53 may be linear operations and some of the remaining operations may not be linear operations. An example of a linear operation other than a convolution operation is, for example, a fully connected operation.

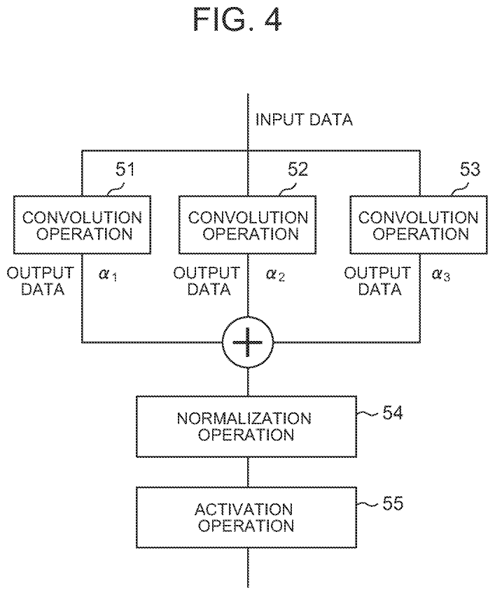

FIG. 4 is a schematic diagram showing an example of a model whose parameters are learned. Although the actual model is followed by more operations, FIG. 4 illustrates a model with a simple structure. In FIG. 4, the convolution operations 51, 52, and 53 are related in that they are given common input data and that the weighted sum of the output data is calculated. Therefore, the convolution operations 51, 52, and 53 correspond to the predetermined multiple operations, similar to the operations 51, 52, and 53 shown in FIG. 1. Therefore, they are denoted by the same codes as operations 51, 52, and 53 shown in FIG. 1. α₁, α₂, and α₃ shown in FIG. 2, FIG. 3, and FIG. 4 are weight values used in calculating the weighted sum of the output data, similar to α₁, α₂, and α₃ shown in FIG. 1.

The parameters of the convolution operation 51, the parameters of the convolution operation 52, and the parameters of the convolution operation 53 are multiple weight values used when performing the convolution operation on the input data (hereinafter referred to as the weight value group). The weight value groups for the convolution operations 51, 52, and 53 are learned by the server and each client in federated learning.

The normalization operation 54 is an operation that performs normalization on the weighted sum of the output data of each of the convolution operations 51, 52, and 53. As already explained, the parameters of the normalization operation 54 are treated as the parameters related to the calculation of the weighted sum. Therefore, the parameters of the normalization operation 54 are learned independently by each client as well as α₁, α₂, and α₃.

Activation operation 55 is an operation that applies an activation function (e.g., ReLU (Rectified Linear Unit)) to the output data of normalization operation 54. The activation operation 55 does not have to have parameters, and the following is an example where the activation function is predetermined and there are no parameters for the activation operation 55. When the parameters of the activation operation 55 are present, they may be learned by the server and each client, in the same way as the parameters of the predetermined multiple operations 51, 52, 53, in federated learning.

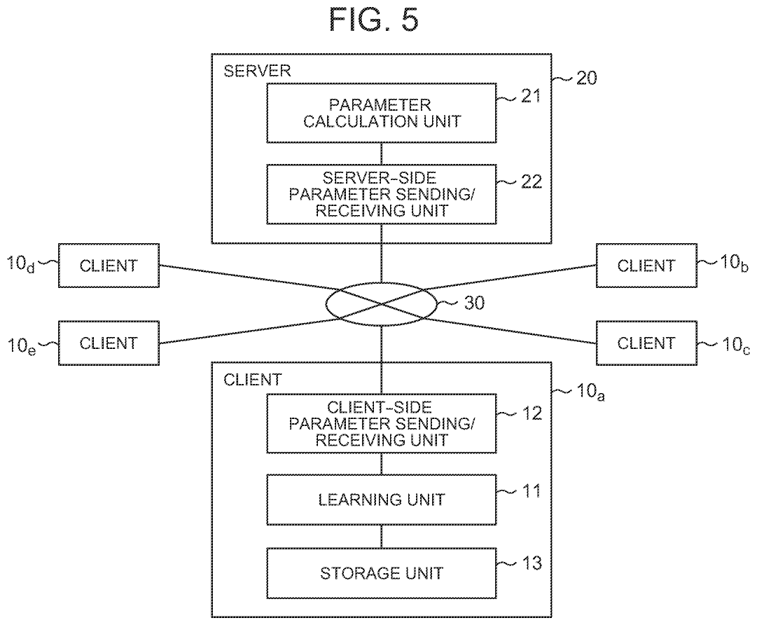

FIG. 5 is a block diagram showing an example configuration of a learning system of the example embodiment of the present invention. In the following, the learning system shown in FIG. 5 is used as an example to learn the parameters of the model shown in FIG. 4.

The learning system of the example embodiment of the present invention includes a server 20 and multiple clients 10ₐ-10ₑ. The server 20 and the multiple clients 10ₐ-10ₑ are communicatively connected via a communication network 30. In FIG. 5, five clients 10ₐ-10ₑ are shown, but the number of clients is not limited to five. However, as mentioned above, there is a restriction that the number of the predetermined multiple operations is lower than the number of the clients. In this example, the number of the predetermined multiple operations (convolution operations 51, 52, 53) is “3” (see FIG. 4) and the number of multiple clients is “5”, thus satisfying this restriction.

Each client 10ₐ-10ₑ has a similar configuration, and when no particular client is distinguished, the client is denoted by the code 10.

Referring to FIG. 5, the configuration of client 10 is described below, using client 10ₐ as an example. The client 10 includes a learning unit 11, a client-side parameter sending/receiving unit 12, and a storage unit 13.

The learning unit 11 uses machine learning to learn the parameters of the predetermined multiple operations (in this example, the weight value group for each of the convolution operations 51, 52, and 53) and the parameters related to the calculation of the weighted sum. In this example, α₁, α₂, α₃, and the parameters of the normalization operation 54 correspond to the parameters related to the calculation of the weighted sum.

The storage unit 13 is a storage device that stores the learning data used by the learning unit 11 to learn the various parameters described above, as well as the model determined by the learned parameters.

Each client's own learning data is pre-stored in the storage unit 13 of each client 10ₐ-10ₑ.

The client-side parameter sending/receiving unit 12 sends, to the server 20, the parameters of the predetermined multiple operations, among the parameters of the predetermined multiple operations (in this example, the weight value group for each of the convolution operations 51, 52, and 53) and the parameters related to the calculation of the weighted sum (in this example, α₁, α₂, α₃, and the parameters of the normalization operation 54).

Therefore, the parameters related to the calculation of the weighted sum (α₁, α₂, α₃, and the parameters of the normalization operation 54) are not sent to the server 20. This means that the parameters related to the calculation of the weighted sum are not learned by the federated learning, but the learning unit 11 of each client 10ₐ-10ₑ learns the parameters related to the calculation of the weighted sum on its own.

The client-side parameter sending/receiving unit 12 also receives from the server 20 the parameters of the predetermined multiple operations (the weight value group for each of the convolution operations 51, 52, and 53) that have been recalculated at the server 20.

Each client 10 is realized, for example, by a computer. The client-side parameter sending/receiving unit 12 is realized, for example, by a CPU (Central Processing Unit) operating according to a learning program and a communication interface of the computer. For example, the CPU may read the learning program from a program storage medium such as a program storage device of the computer, and operate as the client-side parameter sending/receiving part 12 using the communication interface according to the learning program. The communication interface is an interface to the communication network 30. The learning unit 11 is realized, for example, by the CPU operating according to the learning program. For example, the CPU may read the learning program from the program storage medium as described above and operate as the learning unit 11 according to the learning program.

The server 20 includes a parameter calculation unit 21 and a server-side parameter sending/receiving unit 22.

The server-side parameter sending/receiving unit 22 receives the parameters of the predetermined multiple operations (the weight value group for each of the convolution operations 51, 52, and 53) sent by the client-side parameter sending/receiving unit 12 of each client 10.

The server-side parameter sending/receiving unit 22 also sends the parameters of the predetermined multiple operations (the weight value group for each of the convolution operations 51, 52, and 53), which are recalculated by the parameter calculation unit 21, to each client 10. The parameters of the predetermined multiple operations are received by the client-side parameter sending/receiving unit 12 of each client 10.

The parameter calculation unit 21 recalculates the parameters of the predetermined multiple operations based on the parameters of the predetermined multiple operations (the weight value group for each of the convolution operations 51, 52, and 53) received from each client 10 by the server-side parameter sending/receiving unit 22.

For example, the weight values belonging to the weight value group of the convolution operation 51 are different for each of the clients 10 due to differences in the clients 10ₐ-10ₑ. However, the individual weight values belonging to the weight value group of the convolution operation 51 correspond for each client 10ₐ-10ₑ. The parameter calculation unit 21 calculates the average value of the weight value obtained at the client 10ₐ, the weight value obtained at the client 10b, the weight value obtained at the client 10_{c}, the weight value obtained at the client 10ₐ and the weight value obtained at the client 10ₑ for each weight value belonging to the weight value group of the convolution operation 51. By doing so, the weight value group of the convolution operation 51 is recalculated. Similarly, the parameter calculation unit 21 recalculates the weight value group of the convolution operation 52. Similarly, the parameter calculation unit 21 recalculates the weight value group of the convolution operation 53.

As mentioned above, the server-side parameter sending/receiving unit 22 sends the parameters of the predetermined multiple operations (the weight value group for each of the convolution operations 51, 52, and 53), recalculated by the parameter calculation unit 21, to each client 10.

The learning unit 11 of each client 10 learns the parameters of the predetermined multiple operations by machine learning again, using the learning data held independently and the parameters of the predetermined multiple operations received from the server 20, respectively, and also learns the parameters related to the calculation of the weighted sum.

The server 20 is realized, for example, by a computer. The server-side parameter sending/receiving unit 22 is realized, for example, by a CPU operating according to a server program and a communication interface of the computer. For example, the CPU may read the server program from a program storage medium such as a program storage device of the computer, and operate as the server-side parameter sending/receiving unit 22 using the communication interface according to the server program. The communication interface is an interface to the communication network 30. The parameter calculation unit 21 is realized, for example, by the CPU operating according to the server program. For example, the CPU may read the server program from the program storage medium as described above and operate as the parameter calculation unit 21 according to the server program.

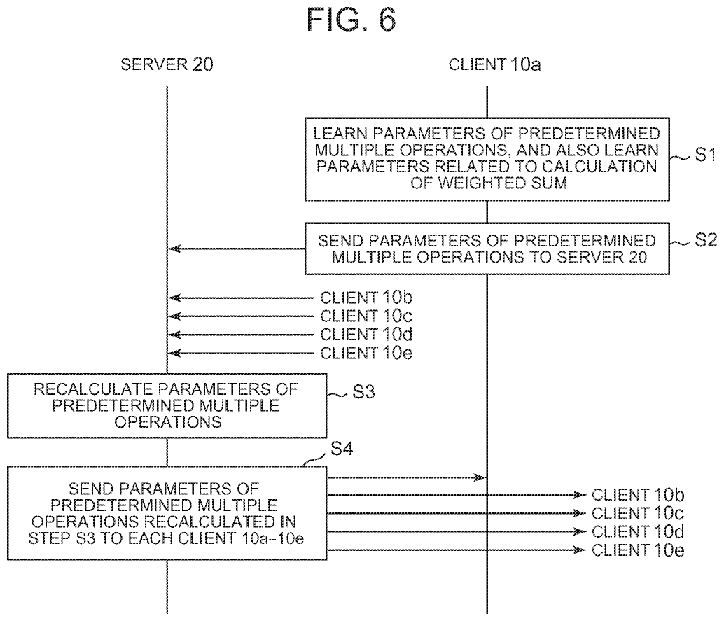

Next, the processing flow of the example embodiment of the present invention will be described. FIG. 6 is a flowchart showing an example of the processing flow of the example embodiment of the present invention. FIG. 6 is an example, and the processing flow of the example embodiment of the present invention is not limited to the example shown in FIG. 6.

In FIG. 6, the behavior of server 20 and client 10ₐ is illustrated, but the behavior of clients 10_{b}-10ₑ is similar to that of client 10ₐ. However, the learning data that each client 10 holds in its storage unit 13 is different for each client 10.

The learning unit 11 of the client 10ₐ learns the parameters of the predetermined multiple operations (the weight value group for each of the convolution operations 51, 52, and 53) by machine learning based on the learning data stored in the storage unit 13, and also learns the parameters related to the calculation of the weighted sum (α₁, α₂, α₃, and the parameters of the normalization operation 54) (step S1).

The learning unit 11 of each of the other clients 10_{b}-10ₑ similarly learns the parameters of the predetermined multiple operations, as well as the parameters related to the calculation of the weighted sum.

Next, the client-side parameter sending/receiving unit 12 of client 10ₐ sends, to the server 20, the parameters of the predetermined multiple operations, among the parameters of the predetermined multiple operations (the weight value group for each of the convolution operations 51, 52, and 53) learned in step S1 and the parameters related to the calculation of the weighted sum (α₁, α₂, α₃, and the parameters of the normalization operation 54) (step S2).

The client-side parameter sending/receiving unit 12 of each of the other clients 10_{b}-10ₑ similarly sends, to the server 20, respectively, the parameters of the predetermined multiple operations, among the parameters of the predetermined multiple operations and the parameters related to the calculation of the weighted sum.

Therefore, the parameters related to the calculation of the weighted sum (α₁, α₂, α₃, and the parameters of the normalization operation 54) are not sent from each client 10ₐ-10ₑ to the server 20.

The server-side parameter sending/receiving unit 22 of server 20 receives the parameters of the predetermined multiple operations (the weight value group for each of the convolution operations 51, 52, and 53) from each client 10ₐ-10ₑ.

Then, the parameter calculation unit 21 of server 20 recalculates the parameters of the predetermined multiple operations based on the parameters of the predetermined multiple operations received from each client 10ₐ-10ₑ (step S3). Examples of behavior in which the parameter calculation unit 21 recalculates the parameters of the predetermined multiple operations have already been described, so the description is omitted here.

Next, the server-side parameter sending/receiving unit 22 sends the parameters of the predetermined multiple operations (the weight value group for each of the convolution operations 51, 52, and 53) recalculated in step S3 to each client 10ₐ-10ₑ (step S4). In step S4, the same parameters are sent to each client 10ₐ-10ₑ.

Each client 10ₐ-10ₑ that receives the parameters sent in step S4 repeats the process from step S1 onward. However, when step S1 is performed after receiving the parameters of the predetermined multiple operations recalculated by the server 20, the learning unit 11 of the client 10ₐ learns the parameters of the predetermined multiple operations (the weight value group for each of the convolution operations 51, 52, and 53), by machine learning, based on the parameters of the predetermined multiple operations and the learning data stored in the storage unit 13, and learns the parameters related to the calculation of the weighted sum (α₁, α₂, α₃, and the parameters of the normalization operation 54). The same is true for the learning unit 11 of the other clients 10_{b}-10ₑ.

As each client 10ₐ-10ₑ repeats the process from step S1 onward, the process of steps S1 to S4 is repeated by each client 10 and server 20. For example, it may be predetermined that the number of repetitions of the process of steps S1 to S4 reaches a predetermined number of times is a condition for completion of learning by each client 10 and server 20 (in other words, federated learning). In this case, for example, the learning unit 11 of each client 10 counts the number of times step S1 is performed, and when the number of times step S1 is performed reaches the predetermined number of times, the parameters of the predetermined multiple operations (the weight value group for each of the convolution operations 51, 52, and 53), and the parameters related to the calculation of the weighted sum (α₁, α₂, α₃, and the parameters of the normalization operation 54) may be determined to be the definite values of the respective parameters, and the model determined by those parameters may be stored in the storage unit 13. The conditions for completion of learning by each client 10 and server 20 are not limited to the above example and may be other conditions.

According to this example embodiment, the parameters of the predetermined multiple operations (the weight value group for each of the convolution operations 51, 52, and 53) are determined by learning (federated learning) by each client 10 and server 20. On the other hand, the parameters related to the calculation of the weighted sum (α₁, α₂, α₃, and the parameters of the normalization operation 54) are learned independently by the learning unit 11 of each client 10. While the parameters of the predetermined multiple operations are common parameters for each client 10, each client 10 can obtain its own unique parameters. In other words, individual parameters can be obtained by the client 10 while including common parameters. And unlike FedProx (see NPL 1), this example embodiment does not use parameter deviation that is not related to the properties of the model (parameter deviation between the global model and the local model). Therefore, each client 10 can obtain parameters that are suitable for each client 10, and a highly accurate model determined by those parameters can be obtained.

Furthermore, in this example embodiment, each client 10 sends and receives parameters with the server 20, but does not send and receive models with each other client. Thus, the possibility of data leakage is reduced compared to FedFomo (see NPL 2).

The number of the predetermined multiple operations is lower than the number of the clients. Therefore, among the predetermined multiple operations, the operations that are important in a client are common to some clients. For example, the event that the value of α₁ becomes large is common to some clients. Similarly, the event that the value of α₂ becomes large is also common to some clients, and the event that the value of α₃ becomes large is also common to some clients. As a result, suitable parameters are obtained for each of the clients 10, and the parameters provide a suitable model for each client. Furthermore, it prevents the properties of those models from being significantly different from each other.

Consider the case where the number of the predetermined multiple operations is higher than the number of the clients. For example, it is assumed that the number of the predetermined multiple operations is 6 and the number of the clients is 3. In this case, the weight values for each operation, α₁-α₆ the parameters. In this case, it can happen that α₁ and α₂ are large for the first client, α₃ and α₄ are large for the second client, and α₅ and α₆ are large for the third client. In this case, the operations that are important in the client would be different in the three clients, and the properties of the models of the three clients would be very different. This can be prevented by ensuring that the number of the predetermined multiple operations is lower than the number of the clients. In other words, it is possible to prevent the properties of each client's model from being too far apart. Thus, it is possible to obtain a model suitable for each client and to prevent the properties of each client's model from differing too much.

Next, a variation of this example embodiment is described. The flowchart shown in FIG. 6 shows a case in which the learning unit 11 learns, in step S1, the parameters of the predetermined multiple operations and also the parameters related to the calculation of the weighted sum. In step S1, the learning unit 11 of each client 10 may learn the parameters of the predetermined multiple operations and may not learn with respect to the parameters related to the calculation of the weighted sum. In this case, the learning unit 11 of each client 10 may learn the parameters related to the calculation of the weighted sum independently after the parameters of the predetermined multiple operations are determined.

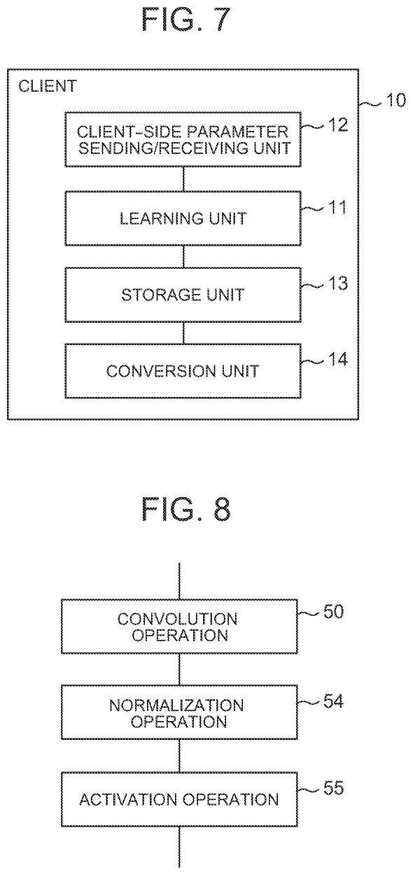

Next, other variation of this example embodiment is described. FIG. 7 is a block diagram showing an example configuration of each client in a variation of the example embodiment of the present invention. Elements similar to those in the above example embodiment are marked with the same codes as in FIG. 5 and the explanation are omitted. The configuration and behavior of the server 20 is the same as the configuration and behavior of the server 20 in the above example embodiment, and the explanation is omitted.

In this variation, it is assumed that the predetermined multiple operations are all linear operations. Therefore, this variation is also explained with reference to FIG. 4. However, the predetermined multiple operations need only be all linear operations, and are not limited to the case where the predetermined multiple operations are all convolution operations, as shown in FIG. 4.

In this variation, the client 10 includes a conversion unit 14 in addition to the learning unit 11, the client-side parameter sending/receiving unit 12, and the storage unit 13.

The behavior up to the point where the definite values of the parameters of the predetermined multiple operations (the weight value group for each of the convolution operations 51, 52, and 53) and the definite values of the parameters related to the calculation of the weighted sum (α₁, α₂, α₃, and the parameters of the normalization operation 54) are determined and the model determined by these parameters is stored in storage unit 13 is the same as in the above example embodiment.

After the parameters of the predetermined multiple operations (the weight value group for each of the convolution operations 51, 52, and 53) and the parameters related to the calculation of the weighted sum (α₁, α₂, α₃, and the parameters of the normalization operation 54) are determined, the conversion unit 14 converts the predetermined multiple operations into a single operation based on the parameters of the predetermined multiple operations and the parameters related to the calculation of the weighted sum.

In the example shown in FIG. 4, after the weight value group for each of the convolution operations 51, 52, and 53, and α₁, α₂, α₃, and the parameters of the normalization operation 54 are determined, the conversion unit 14 converts the convolution operations 51, 52, and 53 into a single convolution operation, based on the weight value group for each of the convolution operations 51, 52, and 53, and α₁, α₂, α₃.

The input data contains multiple numerical values, but is represented here by a single code x for convenience. The weight value group of convolution operation 51 also contains multiple weight values, but is represented here by a single code w₁ for convenience. Similarly, the weight value group of convolution operation 52 and the weight value group of convolution operation 53 are also represented by the codes w₂ and w₃, respectively, for convenience.

The output data obtained by the convolution operation 51 on the input data x is denoted as w₁*x. Similarly, the output data obtained by the convolution operation 52 on the input data x is denoted as w₂*x. Similarly, the output data obtained by the convolution operation 53 on the input data x is denoted as w₃*x.

In this case, the weighted sum of the output data is α₁(w₁*x)+α₂(w₂*x)+α₃(w₃*x). Since the convolution operations 51, 52, 53 are linear operations, this weighted sum can be converted into (α₁w₁+α₂w₂+α₃w₃)*x. Therefore, the conversion unit 14 converts the three convolution operations 51, 52, 53 into a single convolution operation with (α₁w₁+α₂w₂+α₃w₃) as the weight value group. FIG. 8 is a schematic diagram showing a model after conversion by the conversion unit 14. One convolution operation 50 shown in FIG. 8 is an operation converted from the three convolution operations 51, 52, and 53 based on the weight value group for each of the convolution operations 51, 52, and 53, and α₁, α₂, α₃. The weight value group (parameters) of the convolution operation 50 can be expressed schematically as (α₁w₁+α₂w₂+α₃w₃), as shown above.

The conversion unit 14 stores the converted operation and the model determined by the parameters of that operation in the storage unit 13.

Although the example here is the case where the predetermined multiple operations are three, even if the predetermined multiple operations are two or four or more, the conversion unit 14 can convert the parameters of the predetermined multiple operations into a single operation. Also, although the example here is the case where the predetermined multiple operations are all convolution operations, when the predetermined multiple operations are all linear operations, the conversion unit 14 can convert the predetermined multiple operations into a single operation.

According to this variation, the model is simplified by converting the predetermined multiple operations into a single operation. Thus, the amount of calculation can be reduced when performing inference based on the model. For example, comparing FIG. 4 and FIG. 8, the model shown in FIG. 4 requires three convolution operations during inference. On the other hand, the model shown in FIG. 8 requires only one convolution operation during inference.

The conversion unit 14 is realized, for example, by the CPU of the computer operating according to the learning program. For example, the CPU may read the learning program from the program storage medium such as the program storage device of the computer, and operate as the conversion unit 14 according to the learning program.

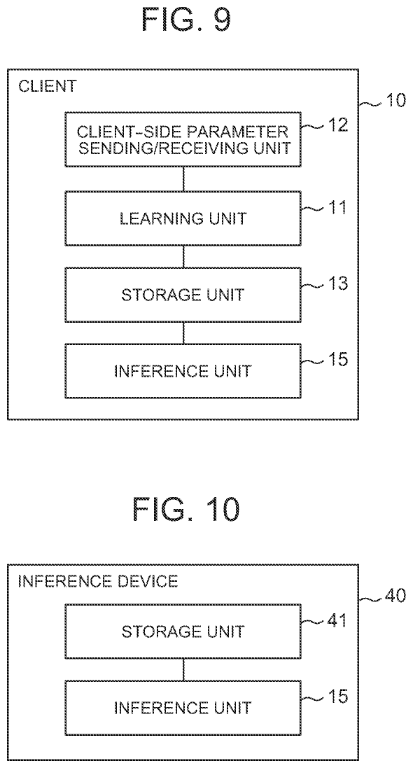

Next, another variation of this example embodiment is described. FIG. 9 is a block diagram showing an example configuration of each client in this variation. Elements similar to those in the above example embodiment are marked with the same codes as in FIG. 5 and the explanation are omitted. The configuration and behavior of the server 20 is the same as the configuration and behavior of the server 20 in the above example embodiment, and the explanation is omitted.

In this variation, the client 10 includes an inference unit 15 in addition to the learning unit 11, the client-side parameter sending/receiving unit 12, and the storage unit 13.

The behavior up to the point where the definite values of the parameters of the predetermined multiple operations (the weight value group for each of the convolution operations 51, 52, and 53) and the definite values of the parameters related to the calculation of the weighted sum (α₁, α₂, α₃, and the parameters of the normalization operation 54) are determined and the model determined by these parameters is stored in storage unit 13 is the same as in the above example embodiment.

In such a way, the parameters of the predetermined multiple operations (the weight value group for each of the convolution operations 51, 52, and 53) and the parameters related to the calculation of the weighted sum (α₁, α₂, α₃, and the parameters of the normalization operation 54) are determined, and when a model determined by the parameters of the predetermined multiple operations and the parameters related to the calculation of the weighted sum is stored in storage unit 13, inference unit 15 performs inference based on the model.

Data is input to the inference unit 15 via an input interface (not shown). The inference unit 15 takes that data as input data for the first operation in the model and calculates the output data for that operation. Then, inference unit 15 takes that output data as the input data for the next operation in the model and calculates the output data for that operation. The inference unit 15 repeats this behavior until the last operation in the model, and derives the output data of the last operation as the inference result. The inference unit 15 may display the inference results obtained based on the data input to the inference unit 15 and the model, for example, on a display device (not shown) provided by the client 10.

According to this variation, not only can a model be obtained that is determined by the parameters being determined, but inference can also be performed by using the model.

The inference part 15 is realized, for example, by the CPU of the computer operating according to the learning program. For example, the CPU may read the learning program from the program storage medium such as the program storage device of the computer, and operate as the inference part 15 according to the learning program.

The client 10 in this variation can be said to be an inference device that performs inference based on the model.

The inference device may be a separate device from the client 10. FIG. 10 is a block diagram showing an inference device that is a separate device from the client 10. The inference device 40 shown in FIG. 10 includes a storage unit 41 and an inference unit 15.

The storage unit 41 is a storage device that stores the same model as the model stored in the storage unit 13 of the client 10 in the above example embodiment or its various variations. The model stored in the storage unit 13 of the client 10 in the above example embodiment or its various variations can be copied to the storage unit 41 of the inference device 40 and the model can be stored in the storage unit 41.

The inference unit 15 is similar to the inference unit 15 provided by the client 10 shown in FIG. 9. That is, data is input to the inference unit 15 via an input interface (not shown). The inference unit 15 takes that data as input data for the first operation in the model and calculates the output data for that operation. Then, inference unit 15 takes that output data as the input data for the next operation in the model and calculates the output data for that operation. The inference unit 15 repeats this behavior until the last operation in the model, and derives the output data of the last operation as the inference result. The inference unit 15 may display the inference result, for example, on a display device (not shown) provided by the inference device 40.

The inference device 40 is realized, for example, by a computer, and the inference unit 15 is realized, for example, by a CPU of the computer operating according to an inference program.

The various variations described above may be realized in combination. For example, the client 10 may include the conversion unit 14 (see FIG. 7) and the inference unit 15 (see FIG. 9).

In the above example embodiment and various variations thereof, a model with a simple configuration shown in FIG. 4 was used as an example. The model to which the example embodiment of the present invention and its various variations are subject to learning may be a model that includes the predetermined multiple operations at multiple locations.

When the predetermined multiple operations are present at multiple locations in the model, the number of the predetermined multiple operations may be different at each location, or the number the predetermined multiple operations may be the same at each location. When the number of the predetermined multiple operations is the same at each location, the number of weight values used to calculate the weighted sum of the output data is also the same at each location. In this case, when the number of the predetermined multiple operations is n, the weight values corresponding to each operation can be expressed as α₁, . . . , αₙ. Then, αᵢ (i is an integer between 1 and n) at each location may be a common value. For example, the learning unit 11 may learn α₁ at each location as a common value, and the same for α₂−αₙ.

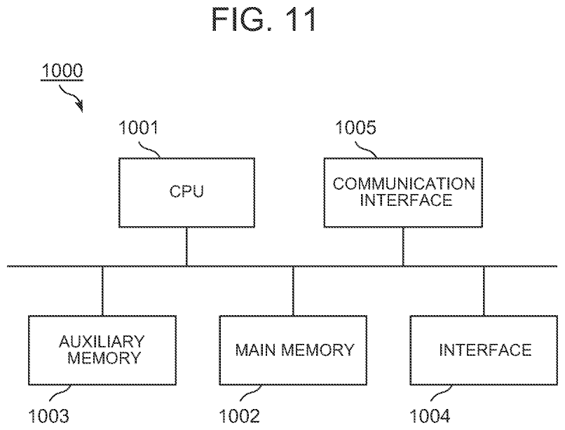

FIG. 11 is a schematic diagram showing an example of computer configuration related to the client 10, the server 20, and the inference device 40 in the example embodiment of the present invention and its various variations. Though explained below with reference to FIG. 11, the computer used as the client 10, the computer used as the server 20, and the computer used as the inference device 40 are separate computers.

Computer 1000 includes a CPU 1001, a main memory 1002, an auxiliary memory 1003, an interface 1004, and a communication interface 1005.

The client 10, server 20, and inference device 40 in the example embodiment of the present invention and its various variations are realized, for example, by computer 1000. However, as mentioned above, the computer used as the client 10, the computer used as the server 20, and the computer used as the inference device 40 are separate computers.

The behavior of the computer 1000 used as the client 10 is stored in the auxiliary memory 1003 in the form of a learning program. The CPU 1001 reads the learning program from the auxiliary memory 1003, expands it in the main memory 1002, and operates as the client 10, and operates as the client 10 in the above example embodiment and its various variations, according to the learning program. The computer 1000 used as the client 10 may include a display device and an input interface through which data is input.

The behavior of the computer 1000 used as the server 20 is stored in the auxiliary memory 1003 in the form of a server program. The CPU 1001 reads the server program from the auxiliary memory 1003, expands it in the main memory 1002, and operates as the server 20 in the above example embodiment and its various variations, according to the server program.

The behavior of the computer 1000 used as the inference device 40 shown in FIG. 10 is stored in the auxiliary memory 1003 in the form of an inference program.

The CPU 1001 reads the inference program from the auxiliary memory 1003, expands it in the main memory 1002, and operates as the inference device 40 according to the inference program. The computer 1000 used as the inference device 40 does not have to include the communication interface 1005. The computer 1000 used as the inference device 40 may also include a display device and an input interface through which data is input.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), semiconductor memory, etc. When the program is delivered to the computer 1000 through a communication line, the computer 1000 receiving the delivery may expand the program into the main memory 1002 and operate according to the program.

Some or all of the components of the client 10 may be realized by general-purpose or dedicated circuitry, processor, or a combination of these. These may comprise a single chip or multiple chips connected via a bus. Some or all of the components may be realized by a combination of the above-mentioned circuitry, etc. and a program. This is also true for the server 20 and the inference device 40 shown in FIG. 10.

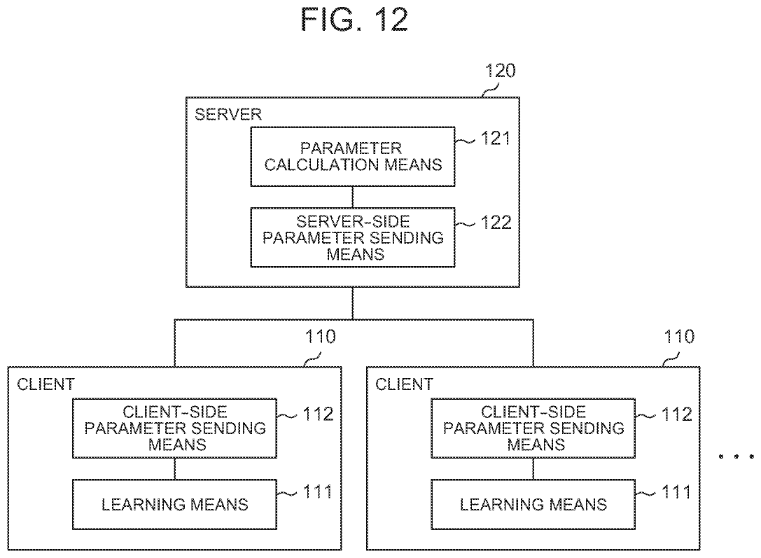

The following is an overview of the present invention. FIG. 12 is a block diagram showing an overview of the learning system of the present invention.

The learning system includes a server 120 (e.g., the server 20) and multiple clients 110 (e.g., the clients 10).

Each client 110 includes learning means 111 (e.g., the learning unit 11) and client-side sending means 112 (e.g., the client-side parameter sending/receiving unit 12).

The learning means 111 learns parameters of predetermined multiple operations (e.g., the operations 51, 52, 53) that are related in that common input data is given and that weighted sum of output data is calculated, and parameters related to calculation of the weighted sum (e.g., α₁, α₂, α₃, and the parameters of the normalization operation 54).

The client-side parameter sending means 112 sends parameters of the predetermined multiple operations, among the parameters of the predetermined multiple operations and the parameters related to the calculation of the weighted sum, to the server 120.

The server 120 includes parameter calculation means 121 (e.g., the parameter calculation unit 21) and server-side parameter sending means 122 (e.g., the server-side parameter sending/receiving unit 22).

The parameter calculation means 121 recalculates the parameters of the predetermined multiple operations, based on the parameters of the predetermined multiple operations received from each client.

The server-side parameter sending means 122 sends the parameters of the predetermined multiple operations to each client 110.

Such a configuration reduces the possibility of data leakage for each client and enables each client to obtain the parameters of a highly accurate model suitable for each client.

The above example embodiment of the present invention and variations thereof may also be described as the following supplementary notes, but are not limited to the following supplementary notes.

### (Supplementary Note 1)

A learning system comprising a server and multiple clients,
wherein each client comprises:
learning means for learning parameters of predetermined multiple operations that are related in that common input data is given and that weighted sum of output data is calculated, and parameters related to calculation of the weighted sum; and
client-side parameter sending means for sending the parameters of the predetermined multiple operations, among the parameters of the predetermined multiple operations and the parameters related to the calculation of the weighted sum, to the server; and
wherein the server comprises:
parameter calculation means for recalculating the parameters of the predetermined multiple operations, based on the parameters of the predetermined multiple operations received from each client; and
server-side parameter sending means for sending the parameters of the predetermined multiple operations to each client.

### (Supplementary Note 2)

The learning system according to supplementary note 1, wherein the learning means of each client learns the parameters related to the calculation of the weighted sum independently.

### (Supplementary Note 3)

The learning system according to supplementary note 1 or 2, wherein the number of the predetermined multiple operations is lower than the number of the multiple clients.

### (Supplementary Note 4)

The learning system according to any one of supplementary notes 1 to 3, wherein the predetermined multiple operations are all linear operations.

### (Supplementary Note 5)

The learning system according to supplementary note 4,
wherein each client comprises:
conversion means for, when the parameters of the predetermined multiple operations and the parameters related to the calculation of the weighted sum are determined, converting the predetermined multiple operations into a single operation based on the parameters of the predetermined multiple operations and the parameters related to the calculation of the weighted sum.

### (Supplementary Note 6)

The learning system according to any one of supplementary notes 1 to 5,
wherein each client comprises:
inference means for, when the parameters of the predetermined multiple operations and the parameters related to the calculation of the weighted sum are determined, deriving an inference result for given data based on a model determined by the parameters of the predetermined multiple operations and the parameters related to the calculation of the weighted sum.

### (Supplementary Note 7)

An inference device comprising:
inference means for deriving an inference result for given data based on a model determined by the parameters of the predetermined multiple operations and the parameters related to the calculation of the weighted sum that are obtained by the learning system according to any one of supplementary notes 1 to 6.

### (Supplementary Note 8)

A learning method performed by a server and multiple clients,
wherein each client
learns parameters of predetermined multiple operations that are related in that common input data is given and that weighted sum of output data is calculated, and parameters related to calculation of the weighted sum; and
sends the parameters of the predetermined multiple operations, among the parameters of the predetermined multiple operations and the parameters related to the calculation of the weighted sum, to the server; and
wherein the server
recalculates the parameters of the predetermined multiple operations, based on the parameters of the predetermined multiple operations received from each client; and
sends the parameters of the predetermined multiple operations to each client.

### (Supplementary Note 9)

The learning method according to supplementary note 8,
wherein each client learns the parameters related to the calculation of the weighted sum independently.

### (Supplementary Note 10)

The learning method according to supplementary note 8 or 9,
wherein the number of the predetermined multiple operations is lower than the number of the multiple clients.

### (Supplementary Note 11)

The learning method according to any one of supplementary notes 8 to 10,
wherein the predetermined multiple operations are all linear operations.

### (Supplementary Note 12)

The learning method according to supplementary note 11,
wherein each client,
when the parameters of the predetermined multiple operations and the parameters related to the calculation of the weighted sum are determined, converts the predetermined multiple operations into a single operation based on the parameters of the predetermined multiple operations and the parameters related to the calculation of the weighted sum.

### (Supplementary Note 13)

A computer-readable recording medium in which a learning program is recorded, wherein the a learning program causes a computer to execute:
a learning process of learning parameters of predetermined multiple operations that are related in that common input data is given and that weighted sum of output data is calculated, and parameters related to calculation of the weighted sum; and
a parameter sending process of sending the parameters of the predetermined multiple operations, among the parameters of the predetermined multiple operations and the parameters related to the calculation of the weighted sum, to a server.

Although the present invention has been described above with reference to the example embodiment, the present invention is not limited to the above example embodiment. Various changes can be made to the configuration and details of the present invention that can be understood by those skilled in the art within the scope of the present invention.

### INDUSTRIAL APPLICABILITY

The present invention is suitably applicable to a learning system for learning parameters of a model.

### REFERENCE SIGNS LIST

10 Client
11 Learning unit
12 Client-side parameter sending/receiving unit
13 Storage unit
14 Conversion unit
15 Inference unit
20 Server
21 Parameter calculation unit
22 Server-side parameter sending/receiving unit
40 Inference device

What is claimed is:

1. A learning system comprising a server and multiple clients,
wherein each client comprises:
a first memory configured to store first instructions; and
a first processor configured to execute the first instructions to:
learn parameters of predetermined multiple operations that are related in that common input data is given and that weighted sum of output data is calculated, and parameters related to calculation of the weighted sum; and
send the parameters of the predetermined multiple operations, among the parameters of the predetermined multiple operations and the parameters related to the calculation of the weighted sum, to the server;
wherein the server comprises:
a second memory configured to store second instructions; and
a second processor configured to execute the second instructions to:
recalculate the parameters of the predetermined multiple operations, based on the parameters of the predetermined multiple operations received from each client; and
send the parameters of the predetermined multiple operations to each client.

2. The learning system according to claim 1,
wherein the first processor of each client learns the parameters related to the calculation of the weighted sum independently.

3. The learning system according to claim 1,
wherein the number of the predetermined multiple operations is lower than the number of the multiple clients.

4. The learning system according to claim 1,
wherein the predetermined multiple operations are all linear operations.

5. The learning system according to claim 4,
wherein the first processor of each client, when the parameters of the predetermined multiple operations and the parameters related to the calculation of the weighted sum are determined, converts the predetermined multiple operations into a single operation based on the parameters of the predetermined multiple operations and the parameters related to the calculation of the weighted sum.

6. The learning system according to claim 1,
wherein the first processor of each client, when the parameters of the predetermined multiple operations and the parameters related to the calculation of the weighted sum are determined, derives an inference result for given data based on a model determined by the parameters of the predetermined multiple operations and the parameters related to the calculation of the weighted sum.

7. An inference device comprising:
a third memory configured to store third instructions; and
a third processor configured to execute the third instructions to:
derive an inference result for given data based on a model determined by the parameters of the predetermined multiple operations and the parameters related to the calculation of the weighted sum that are obtained by the learning system according to claim 1.

8. A learning method performed by a server and multiple clients,
wherein each client
learns parameters of predetermined multiple operations that are related in that common input data is given and that weighted sum of output data is calculated, and parameters related to calculation of the weighted sum; and
sends the parameters of the predetermined multiple operations, among the parameters of the predetermined multiple operations and the parameters related to the calculation of the weighted sum, to the server; and
wherein the server
recalculates the parameters of the predetermined multiple operations, based on the parameters of the predetermined multiple operations received from each client; and
sends the parameters of the predetermined multiple operations to each client.

9. The learning method according to claim 8,
wherein each client learns the parameters related to the calculation of the weighted sum independently.

10. The learning method according to claim 8,
wherein the number of the predetermined multiple operations is lower than the number of the multiple clients.

11. The learning method according to claim 8,
wherein the predetermined multiple operations are all linear operations.

12. The learning method according to claim 11,
wherein each client,
when the parameters of the predetermined multiple operations and the parameters related to the calculation of the weighted sum are determined, converts the predetermined multiple operations into a single operation based on the parameters of the predetermined multiple operations and the parameters related to the calculation of the weighted sum.

13. A non-transitory computer-readable recording medium in which a learning program is recorded, wherein the a learning program causes a computer to execute:
a learning process of learning parameters of predetermined multiple operations that are related in that common input data is given and that weighted sum of output data is calculated, and parameters related to calculation of the weighted sum; and
a parameter sending process of sending the parameters of the predetermined multiple operations, among the parameters of the predetermined multiple operations and the parameters related to the calculation of the weighted sum, to a server.
